(19) United States
(12) Patent Application Publication
(10) Pub. No.: US 2025/0053825 A1
(43) Pub. Date: Feb. 13, 2025

(54) METHOD AND APPARATUS FOR EMBEDDING DATA NETWORK GRAPH, COMPUTER DEVICE, AND STORAGE MEDIUM

(71) Applicant: TENCENT TECHNOLOGY (SHENZHEN) COMPANY LIMITED, Shenzhen (CN)

(72) Inventors: Jie ZHANG, Shenzhen (CN); Wen HUANG, Shenzhen (CN); Jingran DONG, Shenzhen (CN); Shouzhi CHEN, Shenzhen (CN); Chuan CHEN, Shenzhen (CN); Ziyang ZHANG, Shenzhen (CN)

(21) Appl. No.: 18/812,341

(22) Filed: Aug. 22, 2024

Related U.S. Application Data
(63) Continuation of application No. PCT/CN2023/092130, filed on May 5, 2023.

(30) Foreign Application Priority Data
Jul. 29, 2022 (CN) 202210909021.X

(51) Int. Cl. G06N 3/098; G06N 3/042

(52) U.S. Cl. CPC G06N 3/098; G06N 3/042

(57) ABSTRACT

A method for embedding a data network graph includes: performing node feature extraction on a data network graph and a negative sample network graph using a first network embedding model, to obtain a positive sample embedding vector and a negative sample embedding vector performing node feature extraction on a first enhanced graph and a second enhanced graph of the data network graph using the first network embedding model, to obtain a first global embedding vector and a second global embedding vector; determining a first matching degree and a second matching degree; adjusting a parameter of the first network embedding model based on a loss value determined based on the first matching degree and the second matching degree; and performing node feature extraction on the data network graph based on an adjusted first network embedding model, to obtain an embedding vector configured for classifying each node in the data network graph.

### CROSS-REFERENCES TO RELATED APPLICATIONS

This application is a continuation application of PCT Patent Application No. PCT/CN2023/092130, filed on May 5, 2023, which claims priority to Chinese patent application No. 202210909021.X, filed Jul. 29, 2022, all of which is incorporated herein by reference in their entirety.

### FIELD OF THE TECHNOLOGY

The present disclosure relates to the field of artificial intelligence technologies and, in particular, to a method and an apparatus for embedding a data network graph, a computer device, a storage medium, and a computer program product.

### BACKGROUND OF THE DISCLOSURE

In some application scenarios, after a dataset is obtained, data in the dataset needs to be classified. Generally, the obtained dataset is converted into a data network graph, followed by performing node embedding on the data network graph using a network embedding model, to obtain an embedding vector of the data network graph. Classification is then performed using the embedding vector. However, the obtained dataset may be an imbalanced dataset. As a result, differences exist in features between nodes of different categories in the corresponding data network graph. When node classification is performed using the embedding vector of the data network graph, it will lead to poor classification effect.

### SUMMARY

One aspect of the present disclosure provides a method for embedding a data network graph, performed by a computer device. The method includes: performing node feature extraction on the data network graph and a negative sample network graph using a first network embedding model, to obtain a positive sample embedding vector and a negative sample embedding vector, the data network graph being a positive sample network graph and being an imbalanced network graph constructed based on an imbalanced object dataset; performing node feature extraction on a first enhanced graph and a second enhanced graph of the data network graph using the first network embedding model, to obtain a first global embedding vector and a second global embedding vector; determining first matching degrees between the positive sample embedding vector and the first global embedding vector as well as the second global embedding vector, and determining second matching degrees between the negative sample embedding vector and the first global embedding vector as well as the second global embedding vector; determining a loss value based on the first matching degrees and the second matching degrees, and adjusting a parameter of the first network embedding model based on the loss value; and performing node feature extraction on the data network graph based on adjusted first network embedding model, to obtain an embedding vector configured for classifying a node in the data network graph.

Another aspect of the present disclosure provides a computer device. The computer device includes a memory and at least one processor, the memory containing a computer program that, when being executed, causes the at least one processor to implement: performing node feature extraction on the data network graph and a negative sample network graph using a first network embedding model, to obtain a positive sample embedding vector and a negative sample embedding vector, the data network graph being a positive sample network graph and being an imbalanced network graph constructed based on an imbalanced object dataset; performing node feature extraction on a first enhanced graph and a second enhanced graph of the data network graph using the first network embedding model, to obtain a first global embedding vector and a second global embedding vector; determining first matching degrees between the positive sample embedding vector and the first global embedding vector as well as the second global embedding vector, and determining second matching degrees between the negative sample embedding vector and the first global embedding vector as well as the second global embedding vector; determining a loss value based on the first matching degrees and the second matching degrees, and adjusting a parameter of the first network embedding model based on the loss value; and performing node feature extraction on the data network graph based on adjusted first network embedding model, to obtain an embedding vector configured for classifying a node in the data network graph.

Another aspect of the present disclosure provides a non-transitory computer-readable storage medium containing a computer program that, when being executed, causes at least one processor to implement: performing node feature extraction on the data network graph and a negative sample network graph using a first network embedding model, to obtain a positive sample embedding vector and a negative sample embedding vector, the data network graph being a positive sample network graph and being an imbalanced network graph constructed based on an imbalanced object dataset; performing node feature extraction on a first enhanced graph and a second enhanced graph of the data network graph using the first network embedding model, to obtain a first global embedding vector and a second global embedding vector; determining first matching degrees between the positive sample embedding vector and the first global embedding vector as well as the second global embedding vector, and determining second matching degrees between the negative sample embedding vector and the first global embedding vector as well as the second global embedding vector; determining a loss value based on the first matching degrees and the second matching degrees, and adjusting a parameter of the first network embedding model based on the loss value; and performing node feature extraction on the data network graph based on adjusted first network embedding model, to obtain an embedding vector configured for classifying a node in the data network graph.

Details of one or more embodiments of the present disclosure are provided in accompanying drawings and description below. Other features and advantages of the present disclosure are to become apparent from the specification, the accompanying drawings, and the claims.

### BRIEF DESCRIPTION OF THE DRAWINGS

FIG. 1 is a diagram of an application environment of a method for embedding a data network graph according to an embodiment of the present disclosure.

FIG. 2 is a schematic flowchart of a method for embedding a data network graph according to an embodiment of the present disclosure.

FIG. 3 is a schematic diagram of converting a data network graph into a negative sample network graph according to an embodiment of the present disclosure.

FIG. 4 is a schematic diagram of performing data enhancement on a data network graph and performing low-dimensional mapping on an obtained enhanced graph according to an embodiment of the present disclosure.

FIG. 5 is a schematic flowchart of training a second network embedding model and extracting structural information, and obtaining a target embedding vector based on the structural information and an embedding vector according to an embodiment of the present disclosure.

FIG. 6 is a schematic diagram of training a first graph convolutional network model, a second graph convolutional network model, and a classifier according to an embodiment of the present disclosure.

FIG. 7 is a structural block diagram of an apparatus for embedding a data network graph according to an embodiment of the present disclosure.

FIG. 8 is a structural block diagram of an apparatus for embedding a data network graph according to another embodiment of the present disclosure.

FIG. 9 is a diagram of an internal structure of a computer device according to an embodiment of the present disclosure.

### DESCRIPTION OF EMBODIMENTS

To make objectives, technical solutions, and advantages of the present disclosure clearer and more comprehensible, the present disclosure is described in further detail below with reference to the accompanying drawings and embodiments. The specific embodiments described herein are merely configured for explaining the present disclosure but are not intended to limit the present disclosure.

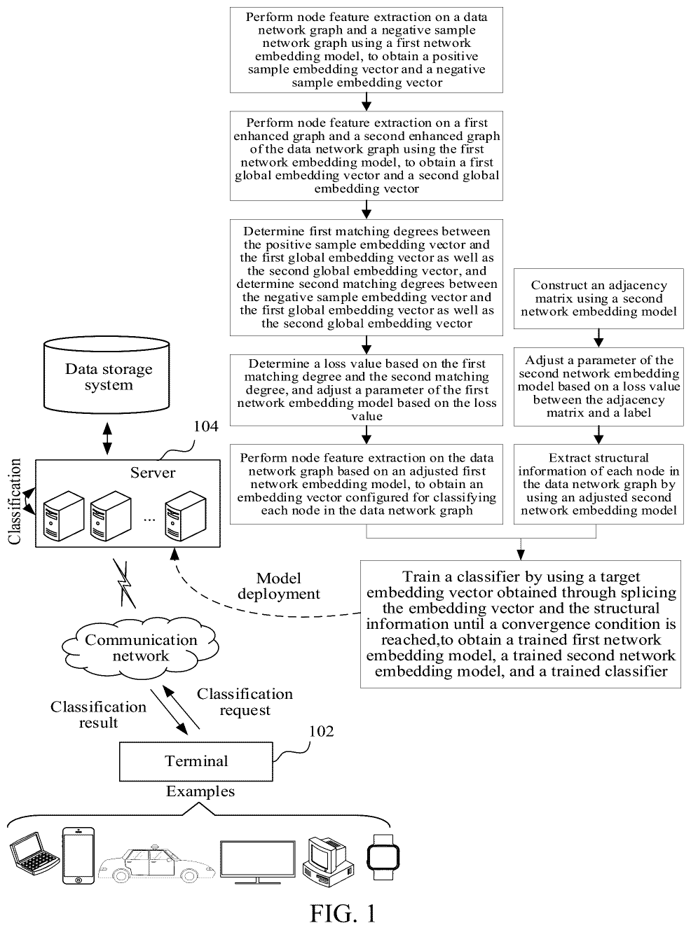

A method for embedding a data network graph provided in an embodiment of the present disclosure may be applied to an application environment shown in FIG. 1. As shown, a terminal 102 communicates with a server 104 through a network. A data storage system may store data that the server 104 uses to process. The data storage system may be integrated on the server 104, or may be placed on a cloud or another network server.

The server 104 performs node feature extraction on the data network graph and a negative sample network graph using a first network embedding model, to obtain a positive sample embedding vector and a negative sample embedding vector, the data network graph being a positive sample network graph; performs node feature extraction on a first enhanced graph and a second enhanced graph of the data network graph using the first network embedding model, to obtain a first global embedding vector and a second global embedding vector; determines first matching degrees between the positive sample embedding vector and the first global embedding vector as well as the second global embedding vector, and determines second matching degrees between the negative sample embedding vector and the first global embedding vector as well as the second global embedding vector; determines a loss value based on the first matching degree and the second matching degree, and adjusts a parameter of the first network embedding model based on the loss value; and performs node feature extraction on the data network graph based on an adjusted first network embedding model, to obtain an embedding vector configured for classifying each node in the data network graph. In addition, an adjacency matrix may be constructed using a second network embedding model, and a parameter of the second network embedding model is adjusted based on a loss value between the adjacency matrix and a real adjacency matrix, to minimize the loss value between the adjacency matrix and the real adjacency matrix, so that the model can learn structural information consistent with or close to the real adjacency matrix. The structural information is spliced with the embedding vector, to obtain a new target embedding vector configured for classifying each node in the data network graph, a classifier is trained using the target embedding vector, and a trained first network embedding model, a trained second network embedding model, and a trained classifier are deployed. When a classification task needs to be performed, the terminal 102 may initiate a classification request. In response to the classification request, the server 104 invokes the first network embedding model and the second network embedding model to perform feature extraction and splicing, and classifies, using the classifier, the target embedding vector obtained through splicing, to obtain a classification result, as shown in FIG. 1.

Alternatively, after obtaining the embedding vector configured for classifying each node in the data network graph, the server 104 may directly train a classifier using the embedding vector, and deploy a trained first network embedding model and a trained classifier. When a classification task needs to be performed, the terminal 102 may initiate a classification request. In response to the classification request, the server 104 invokes the first network embedding model to perform feature extraction, and classifies the extracted target embedding vector using the classifier, to obtain a classification result.

The terminal 102 may be a smartphone, a tablet computer, a notebook computer, a desktop computer, a smart speaker, a smart watch, an Internet of Things device, or a portable wearable device. The Internet of Things device may be a smart speaker, a smart television, a smart air conditioner, a smart in-vehicle device, or the like. The portable wearable device may be a smart watch, a smart band, a head-mounted device, or the like.

The server 104 may be an independent physical server, or may be a serving node in a blockchain system. A peer-to-peer (P2P) network is formed between serving nodes in the blockchain system. A P2P protocol is an application-layer protocol running over a transmission control protocol (TCP).

In addition, the server 104 may alternatively be a server cluster formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, or an artificial intelligence platform.

The terminal 102 and the server 104 may be connected in a communication connection manner such as Bluetooth, a universal serial bus (USB), or a network. This is not limited in the present disclosure.

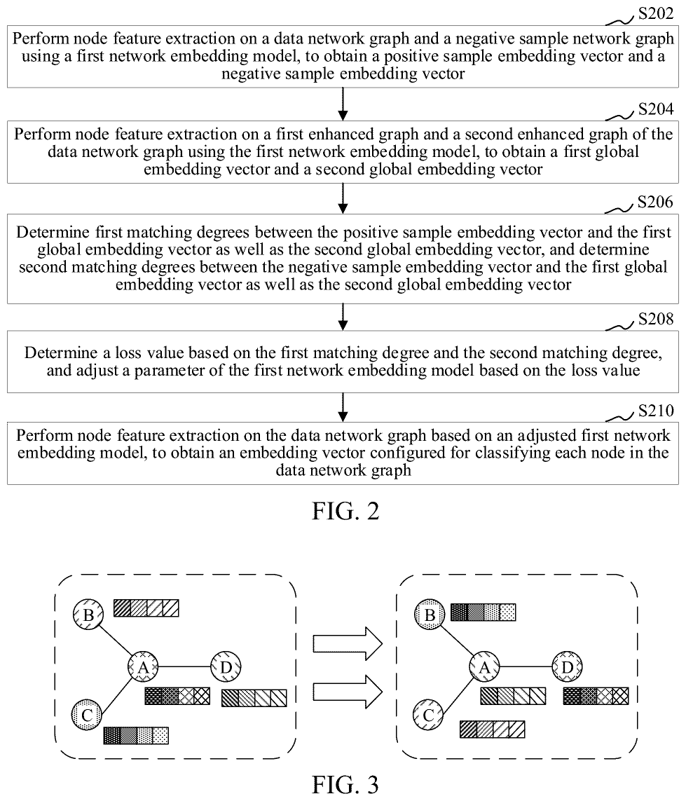

In an embodiment, as shown in FIG. 2, a method for embedding a data network graph is provided. An example in which the method is applied to the server 104 in FIG. 1 is used for description, and the method includes the following operations.

S202: Perform node feature extraction on the data network graph and a negative sample network graph using a first network embedding model, to obtain a positive sample embedding vector and a negative sample embedding vector.

The data network graph is a positive sample network graph and is an imbalanced network graph constructed based on an imbalanced object dataset. Specifically, the data network graph is an imbalanced network graph constructed using each piece of object data in the imbalanced object dataset as a node and using an association relationship as an edge of the node. In a document citation scenario, the object data may be document data and cited data corresponding to a document interaction object. Therefore, the data network graph may be a positive sample document citation relationship graph. In a media interaction scenario, the object data may be media data and interaction data corresponding to a media interaction object. Therefore, the data network graph may be a positive sample media interaction graph. In a social scenario, the object data may be social object data and social relationship data. Therefore, the data network graph may be a positive sample social relationship graph. The data network graph is a graphical dataset, and therefore may also be referred to as a graph dataset. The object dataset belongs to an imbalanced data set (referred to as an imbalanced dataset for short), representing a large difference in quantities of different types of object data in the object dataset. There may be a plurality of data network graphs.

The negative sample network graph may be a network graph that has a feature difference with the data network graph, and a node structure of the negative sample network graph may be consistent with a node structure of the data network graph, as shown in FIG. 3.

The first network embedding model belongs to a self-supervised learning module, and is configured to map each node in the data network graph and the negative sample network graph to a low-dimensional space. Specifically, the first network embedding model may be a graph convolutional network (GCN) model, a graph attention network (GAN) model, or a graph isomorphism network (GIN) model. The graph convolutional network model may be a network model including at least one layer of graph convolutional network. The positive sample embedding vector and the negative sample embedding vector extracted by the first network embedding model are local embedding vectors of nodes in the data network graph and the negative sample network graph respectively, and belong to feature vectors in the low-dimensional space. Corresponding feature matrixes of the nodes in the data network graph and the negative sample network graph belong to feature vectors in a high-dimensional space.

In an embodiment, before S202, the server obtains an object dataset and an association relationship between each piece of object data in the object dataset. The object dataset belongs to an imbalanced dataset. The data network graph is constructed using each piece of object data in the object dataset as a node and using the association relationship as an edge of the node.

The object data in the object dataset may be document data, and the corresponding association relationship may be a citation relationship. In addition, the object data in the object dataset may alternatively be media data and object information, and the corresponding association relationship may be an interaction relationship. For example, an object taps/clicks on the media data, so that there is an interaction relationship between the media data and the object. In addition, the object data in the object dataset may alternatively be social object data, and the corresponding association relationship may be a friend relationship existing between social objects.

In an embodiment, after the data network graph is constructed, the server may further perform out-of-order processing on a feature corresponding to each node in the data network graph, to obtain the negative sample network graph. For example, the server may input an initial feature matrix and an adjacency matrix (namely, structural information of the nodes) of the nodes in the data network graph into an erosion function, so that the negative sample network graph can be generated. An expression of the erosion function is as follows:

(X′,A′)=C(X,A)

A′=A, A represents the adjacency matrix of the nodes in the data network graph, and A′ represents an adjacency matrix of nodes in the negative sample network graph. X′=Shuffle (X), X represents a feature matrix of the nodes in the data network graph, \tilde{X} represents a feature matrix of the nodes in the negative sample network graph, and Shuffle ( ) represents performing out-of-order processing X.

Therefore, for a schematic diagram of processing the data network graph using the erosion function, reference may be made to FIG. 3. In the erosion function, the node structure in the data network graph is kept unchanged, and the out-of-order processing on the feature of each node in the data network graph is randomly performed.

In an embodiment, the server extracts an embedding vector of each node in the data network graph using the first network embedding model, to obtain the positive sample embedding vector of each node in the data network graph; and the server extracts an embedding vector of each node in the negative sample network graph using the first network embedding model, to obtain the negative sample embedding vector of each node in the negative sample network graph.

Specifically, the server obtains the adjacency matrix and the feature matrix of the nodes in the data network graph; inputs the adjacency matrix and the feature matrix of the nodes in the data network graph into the first network embedding model, to cause the first network embedding model to generate the positive sample embedding vector of each node in the data network graph based on the inputted adjacency matrix, a degree matrix of the adjacency matrix, the feature matrix, and a weight matrix of the first network embedding model; obtains the adjacency matrix and the feature matrix of the nodes in the negative sample network graph; and inputs the adjacency matrix and the feature matrix of the nodes in the negative sample network graph into the first network embedding model, to cause the first network embedding model to generate the negative sample embedding vector of each node in the negative sample network graph based on the inputted adjacency matrix, a degree matrix of the adjacency matrix, the feature matrix, and the weight matrix of the first network embedding model. The first network embedding model may include two network embedding branches, and the two network embedding branches respectively perform node feature extraction on different network graphs.

For example, for the node feature extraction on the data network graph, when the first network embedding model is a network model including one layer of graph convolutional network, the first network embedding model adds a loop to the adjacency matrix of the nodes in the data network graph, to obtain an adjacency matrix having the loop, and then determines the positive sample embedding vector based on the adjacency matrix with the loop added, a degree matrix of the adjacency matrix, the feature matrix, and a weight matrix of the graph convolutional network.

When the first network embedding model is a network model including a plurality of layers of graph convolutional networks, a first-layer graph convolutional network of the first network embedding model adds a loop to the adjacency matrix of the nodes in the data network graph, to obtain an adjacency matrix having the loop, and then determines an embedding vector outputted by the first-layer graph convolutional network based on the adjacency matrix with the loop added, a degree matrix, the feature matrix, and a weight matrix of the first-layer graph convolutional network; and then the embedding vector outputted by the first-layer graph convolutional network is used as input data of a second-layer graph convolutional network, and an embedding vector outputted by the second-layer graph convolutional network is determined based on the adjacency matrix with the loop added, the degree matrix, the input data of the second-layer graph convolutional network, and a weight matrix of the second-layer graph convolutional network, and so on, to obtain an embedding vector outputted by a last-layer graph convolutional network, and the embedding vector outputted by the last-layer graph convolutional network is used as the positive sample embedding vector. To clearly describe the foregoing calculation process, a calculation formula of each layer of graph convolutional network is given herein, and details are as follows:

$${H}^{( l + 1 )} = σ ( {\tilde{D}}^{- \frac{1}{2}} \tilde{A} {\tilde{D}}^{- \frac{1}{2}} {H}^{( l )} {W}^{( l )} )$$

where H^{(l)} represents an embedding vector outputted by an I^{th}-layer graph convolutional network during processing of the data network graph; A is the adjacency matrix of the nodes in the data network graph, and Ã=A+I is an adjacency matrix with a loop/added; \tilde{D} is a degree matrix of Ã; W^{(l)} is a weight matrix of the I′-layer graph convolutional network; and σ ( ) is an activation function. Particularly, when l=0, H^{(o)}=X, and X represents the feature matrix of the nodes in the data network graph. If the first network embedding model has N layers of graph convolutional networks in total, when l=N−1,

$${H}^{( N )} = σ ( {\tilde{D}}^{- \frac{1}{2}} \tilde{A} {\tilde{D}}^{- \frac{1}{2}} {H}^{( N - 1 )} {W}^{( N - 1 )} )$$

is the positive sample embedding vector of each node in the data network graph.

For a positive sample embedding vector

$${h}_{i} = {H}_{i}^{N} = σ ( {\tilde{D}}_{i}^{- \frac{1}{2}} {\tilde{A}}_{i} {\tilde{D}}_{i}^{- \frac{1}{2}} {H}_{i}^{( N - 1 )} {W}^{( N - 1 )} )$$

of an i^{th} node in the data network graph, Ãᵢ is an adjacency matrix with a loop added of the i^{th} node, and \tilde{D}ᵢ is a degree matrix of Ãᵢ; and Hᵢ^{(N-1)} is an embedding vector related with the i^{th} node in the data network graph outputted by an (N−1)^{th}-layer graph convolutional network and is.

Similarly, the negative sample embedding vector may be calculated with reference to the following calculation formula:

$${H}^{′ ( l + 1 )} = σ ( {- \frac{1}{2}}^{} \tilde{{A}^{′}} {- \frac{1}{2}}^{} {H}^{′ ( l )} {W}^{( l )} )$$

where H′^{(l)} represents an embedding vector outputted by an I^{th}-layer graph convolutional network during processing of the negative sample network graph; A′ is the adjacency matrix of the nodes in the negative sample network graph, and Ã′=A′+I is an adjacency matrix with a loop I added; and [symbol] is a degree matrix of Ã′. Particularly, when l=0, H′^{(o)}=X′, and X′ represents the feature matrix of the nodes in the negative sample network graph. If the first network embedding model has N layers of graph convolutional networks in total, when

$$l = N - 1 ,$$

$${H}^{′ ( N )} = σ ( {- \frac{1}{2}}^{} {\tilde{A}}^{′} {{\tilde{D}}^{′}}^{- \frac{1}{2}} {{H}^{′}}^{( N - 1 )} {W}^{( N - 1 )} )$$

is the negative sample embedding vector of each node in the negative sample network graph.

For a negative sample embedding vector

$${h}_{i}^{′} = {{H}^{′}}_{i}^{N} = σ ( {i}_{- \frac{1}{2}}^{} {\tilde{A}}_{i}^{′} {i}_{- \frac{1}{2}}^{} {{H}_{i}^{′}}^{( N - 1 )} {W}^{( N - 1 )} )$$

of an i^{th} node in the negative sample network graph, Ã′ᵢ is an adjacency matrix of the i^{th} node in the negative sample network graph, and [symbol] ᵢ is a degree matrix of Ãᵢ; and H′ᵢ^{(N-1)} is a negative sample embedding vector related with the i^{th} node in the negative sample network graph outputted by an (N−1)^{th}-layer graph convolutional network.

S204: Perform node feature extraction on a first enhanced graph and a second enhanced graph of the data network graph using the first network embedding model, to obtain a first global embedding vector and a second global embedding vector.

The first enhanced graph and the second enhanced graph are respectively enhanced graphs obtained by performing data enhancement on the data network graph. The first global embedding vector and the second global embedding vector are respectively global embedding vectors of nodes in the first enhanced graph and the second enhanced graph, and belong to feature vectors in the low-dimensional space.

In an embodiment, S204 may specifically include: The server extracts a first local embedding vector and a second local embedding vector of each node from the first enhanced graph and the second enhanced graph respectively using the first network embedding model; and performs pooling on the first local embedding vector and the second local embedding vector respectively, to obtain the first global embedding vector and the second global embedding vector.

The first local embedding vector and the second local embedding vector are respectively local embedding vectors of the nodes in the first enhanced graph and the second enhanced graph, and also belong to feature vectors in the low-dimensional space. The pooling may be average pooling, maximum pooling, or the like.

The operation of extracting the first local embedding vector and the second local embedding vector includes: The server obtains a first adjacency matrix and a first feature matrix of nodes in the first enhanced graph; inputs the first adjacency matrix and the first feature matrix into the first network embedding model, to cause the first network embedding model to add a loop to the first adjacency matrix and generate the first local embedding vector of each node in the first enhanced graph based on a first adjacency matrix with the loop, a first degree matrix, the first feature matrix, and the weight matrix of the first network embedding model; obtains a second adjacency matrix and a second feature matrix of nodes in the second enhanced graph; and the server further inputs the second adjacency matrix and the second feature matrix into the first network embedding model, to cause the first network embedding model to add a loop to the second adjacency matrix and generate the second local embedding vector of each node in the second enhanced graph based on a second adjacency matrix with the loop, a second degree matrix, the second feature matrix, and the weight matrix.

For example, when the first network embedding model is a network model including one layer of graph convolutional network, the first network embedding model adds the loop to the first adjacency matrix, and determines the first local embedding vector of each node in the first enhanced graph based on the first adjacency matrix with the loop, the first degree matrix, the first feature matrix, and the weight matrix of the graph convolutional network.

When the first network embedding model is a network model including a plurality of layers of graph convolutional networks, a first-layer graph convolutional network of the first network embedding model adds the loop to the first adjacency matrix, and determines an embedding vector outputted by the first-layer graph convolutional network based on the first adjacency matrix with the loop added, the first degree matrix, the first feature matrix, and the weight matrix of the first-layer graph convolutional network; and then the embedding vector outputted by the first-layer graph convolutional network is used as input data of a second-layer graph convolutional network, and an embedding vector outputted by the second-layer graph convolutional network is determined based on the first adjacency matrix with the loop added, the first degree matrix, the input data of the second-layer graph convolutional network, and a weight matrix of the second-layer graph convolutional network, and so on, to obtain an embedding vector outputted by a last-layer graph convolutional network, and the embedding vector outputted by the last-layer graph convolutional network is used as the first local embedding vector of each node in the first enhanced graph. To clearly describe the foregoing calculation process, a calculation formula of each layer of graph convolutional network is given herein, and details are as follows:

$${H}_{a}^{( l + 1 )} = σ ( {\tilde{D}}_{a}^{- \frac{1}{2}} {\tilde{A}}_{a} {\tilde{D}}_{a}^{- \frac{1}{2}} {\tilde{A}}_{a} {H}_{a}^{( l )} {W}^{( l )} )$$

where Hₐ^{(l)} represents an embedding vector outputted by an l^{th}-layer graph convolutional network during processing of the first enhanced graph; Aₐ is the first adjacency matrix of the nodes in the first enhanced graph, and Ãₐ is a first adjacency matrix with a loop added; and \tilde{D} is a first degree matrix of Ãₐ; W^{(l)} is a weight matrix of the I^{th}-layer graph convolutional network; and σ ( ) is an activation function. Particularly, when l=0, Hₐ⁽⁰⁾=Xₐ, and Xₐ represents the first feature matrix of the nodes in the first enhanced graph. If the first network embedding model has N layers of graph convolutional networks in total, when l=N−1, Hₐ^{(N)}=

$${H}_{a} = σ ( {\tilde{D}}_{a}^{- \frac{1}{2}} {\tilde{A}}_{a} {\tilde{D}}_{a}^{- \frac{1}{2}} {\tilde{A}}_{a} {H}_{a}^{( N - 1 )} {W}^{( N - 1 )} )$$

is the first local embedding vector of each node in the first enhanced graph.

Similarly, the second local embedding vector may be calculated with reference to the following calculation formula:

$${H}_{b}^{( l + 1 )} = σ ( {\tilde{D}}_{b}^{- \frac{1}{2}} {\tilde{A}}_{b} {\tilde{D}}_{b}^{- \frac{1}{2}} {\tilde{A}}_{b} {H}_{b}^{( l )} {W}^{( l )} )$$

where H_{b}^{(l)} represents an embedding vector outputted by an l^{th}-layer graph convolutional network during processing of the second enhanced graph; A_{b} is the second adjacency matrix of the nodes in the second enhanced graph, and Ã_{b} is a second adjacency matrix with a loop added; and \tilde{D} is a second degree matrix of Ã_{b}. Particularly, when l=0, H_{b}⁽⁰⁾=X_{b}, and X_{b} represents the second feature matrix of the nodes in the second enhanced graph. If the second network embedding model has N layers of graph convolutional networks, when l=N−1,

$${H}_{b}^{( N )} = {H}_{b} = σ ( {\tilde{D}}_{b}^{- \frac{1}{2}} {\tilde{A}}_{b} {\tilde{D}}_{b}^{- \frac{1}{2}} {\tilde{A}}_{b} {H}_{b}^{( N - 1 )} {W}^{( N - 1 )} )$$

is the second local embedding vector of each node in the second enhanced graph.

After the first local embedding vector and the second local embedding vector are calculated, the server may respectively convert the first local embedding vector and the second local embedding vector into the first global embedding vector and the second global embedding vector using a conversion function. If the conversion function is a Readout ( ) function, then:
the first global embedding vector sₐ=Readout(Hₐ); and
the second global embedding vector s_{b}=Readout(H_{b}).

Readout (Hₐ) and Readout (H_{b}) may be performing average pooling or maximum pooling on Hₐ and H_{b}, to respectively obtain the first global embedding vector and the second global embedding vector. Because a global embedding vector is common to all nodes in a graph, each node in the first enhanced graph has the same first global embedding vector, and each node in the second enhanced graph also has the same second global embedding vector.

S206: Determine first matching degrees between the positive sample embedding vector and the first global embedding vector as well as the second global embedding vector, and determine second matching degrees between the negative sample embedding vector and the first global embedding vector as well as the second global embedding vector.

Both the first enhanced graph and the second enhanced graph are obtained by performing data enhancement on the data network graph, so that the positive sample embedding vector has a high matching degree with the first global embedding vector and the second global embedding vector, and the negative sample embedding vector has a low matching degree with the first global embedding vector and the second global embedding vector. Therefore, the first matching degree is greater than the second matching degree.

The first matching degrees may be matching degrees between the positive sample embedding vector and the first global embedding vector as well as the second global embedding vector. The second matching degrees may be matching degrees between the negative sample embedding vector and the first global embedding vector as well as the second global embedding vector.

In an embodiment, the server may calculate a similarity score between the positive sample embedding vector and the first global embedding vector and a similarity score between the positive sample embedding vector and the second global embedding vector using a discriminator, and use the calculated similarity scores as the first matching degrees between the positive sample embedding vector and the first global embedding vector as well as the second global embedding vector respectively. In addition, the server may further calculate a similarity score between the negative sample embedding vector and the first global embedding vector and a similarity score between the negative sample embedding vector and the second global embedding vector using the discriminator, and use the calculated similarity scores as the second matching degrees between the negative sample embedding vector and the first global embedding vector as well as the second global embedding vector respectively.

The discriminator may be considered as a scoring function. A similarity score may be calculated using the discriminator, so that a matching degree between a local embedding vector of the data network graph and a global embedding vector of the enhanced graph can be reflected, and a matching degree between a local embedding vector of the negative sample network graph and the global embedding vector of the enhanced graph can be reflected. A function expression of the discriminator is as follows:

D(hᵢ,s)=σ(hᵢ^{T}W_{b}s)

where hᵢ may represent a positive sample embedding vector of an i^{th} node in the data network graph, or a negative sample embedding vector of an i^{th} node in the negative sample network graph; s may represent the first global embedding vector of the first enhanced graph, or the second global embedding vector of the second enhanced graph; and W_{b} is a learnable mapping matrix.

S208: Determine a loss value based on the first matching degree and the second matching degree, and adjust a parameter of the first network embedding model based on the loss value.

The parameter of the first network embedding model may be a weight parameter of the first network embedding model. Each layer of network in the first network embedding model has corresponding weight parameters. The weight parameters of each layer of network are combined to obtain a weight matrix of the layer of network.

Specifically, the server performs back propagation on the loss value in the first network embedding model, to obtain a gradient of each parameter in the first network embedding model, and adjusts the parameter of the first network embedding model based on the gradient.

For calculation of the loss value, a calculation operation may specifically include: The server determines a quantity of nodes in the data network graph and a quantity of nodes in the negative sample network graph, and then inputs the quantity of nodes in the data network graph, the quantity of nodes in the negative sample network graph, the first matching degree, and the second matching degree into an objective function, to obtain the loss value. After obtaining the loss value, the server may adjust the parameter of the first network embedding model based on the loss value, to optimize the parameter of the first network embedding model, to minimize a value of the objective function.

In an unsupervised training form, to learn a high-quality embedding vector, an error value between an initial feature matrix and a reconstructed feature matrix is not minimized, and mutual information between the foregoing two variables is maximized instead. For example, a loss value between an initial feature matrix of the nodes in the data network graph and the positive sample embedding vector of each node in the data network graph is not minimized, and mutual information between the foregoing two variables is maximized instead, so that the embedding vector learned by the first network embedding model includes as much key information (for example, the most unique and important information) in the data network graph as possible. In addition, because the mutual information is a Kullback Leibler (KL) divergence between a joint distribution of the two variables and a product of marginal distributions of the two variables, to maximize the mutual information, a distance between the joint distribution and the product of the marginal distributions needs to be increased. To simplify difficulties of solving, the KL divergence may be converted into a Jensen Shannon (JS) divergence. A conversion formula between the KL divergence and the JS divergence is as follows:

$$JS ( X , Y ) = \frac{1}{2} KL ( X ‖ \frac{X + Y}{2} ) + \frac{1}{2} KL ( Y ‖ \frac{X + Y}{2} )$$

The foregoing conversion formula may further be simplified and approximated through negative sampling and a network model, to obtain a function L′ similar to a loss function. The function L′ is as follows:

$${L}^{′} = \frac{1}{N + M} ( {{\sum }^{N}}_{i = 1} {E}_{( X , A )} [ log D ( {h}_{i} , s ) ] + {{\sum }^{M}}_{i = 1} {E}_{( {X}^{′} , {A}^{′} )} [ log ( 1 - D ( {h}_{i}^{′} , s ) ) ] )$$

where E_{(X,A)}[ ] and E_{(X′,A′)}[ ] are expectation functions, E_{(X,A)}[ ] represents calculating an expected value of log D(hᵢ, s), and E_{(X′ A′)}[ ] represents calculating an expected value of 1−D (h′ᵢ, s). In actual application, E_{(X,A)}[log D(hᵢ, s)]=log D(hᵢ, s), and E_{(X′,A′)}[log (1−D(h′ᵢ, s))]=log (1−D(h′ᵢ,s)), that is,

$${L}^{′} = \frac{1}{N + M} ( {\sum }_{i = 1}^{N} log D ( {h}_{i} , s ) + {\sum }_{i = 1}^{M} log ( 1 - D ( {h}_{i}^{′} , s ) ) ) .$$

Because s may represent the first global embedding vector of the first enhanced graph, or the second global embedding vector of the second enhanced graph, the objective function may be obtained based on the foregoing function L′, and the objective function is as follows:

$$L = \frac{1}{N + M} ( {{\sum }^{N}}_{i = 1} {E}_{( X , A )} [ log D ( {h}_{i} , {s}_{a} ) ] + {{\sum }^{M}}_{i = 1} {E}_{( {X}^{′} , {A}^{′} )} [ log ( 1 - D ( {h}_{i}^{′} , {s}_{a} ) ) ] ) + \frac{1}{N + M} ( {{\sum }^{N}}_{i = 1} {E}_{( X , A )} [ log D ( {h}_{i} , {s}_{b} ) ] + {{\sum }^{M}}_{i = 1} {E}_{( {X}^{′} , {A}^{′} )} [ log ( 1 - D ( {h}_{i}^{′} , {s}_{b} ) ) ] )$$

According to E_{(X,A)}[log D(hᵢ, s)]=log D(hᵢ, s) and E_{(X′,A′)}[log (1−D(h′ᵢ, s))]=log (1−D (h′ᵢ, s)), the foregoing expression may be simplified, to obtain:

$$L = \frac{1}{N + M} ( {{\sum }^{N}}_{i = 1} log D ( {h}_{i} , {s}_{a} ) + {{\sum }^{M}}_{i = 1} log ( 1 - D ( {h}_{i}^{′} , {s}_{a} ) ) ) + \frac{1}{N + M} ( {{\sum }^{N}}_{i = 1} log D ( {h}_{i} , {s}_{b} ) + {{\sum }^{M}}_{i = 1} log ( 1 - D ( {h}_{i}^{′} , {s}_{b} ) ) )$$

Therefore, the loss value may be determined based on the quantity of nodes in the data network graph, the quantity of nodes in the negative sample network graph, the first matching degree, and the second matching degree. By continuously adjusting the parameter of the first network embedding model, the value of the loss function may be minimized. By minimizing the value of the objective function, the mutual information between the original feature matrix and the reconstructed feature matrix may be maximized, and consistency of embedding of the nodes in the data network graph in enhanced graphs at two different perspectives may be maximized. For example, by minimizing the value of the objective function, the mutual information between the initial feature matrix of the nodes in the data network graph and the positive sample embedding vector of each node in the data network graph may be maximized, and the mutual information between the initial feature matrix of the nodes in the first enhanced graph and the first local embedding vector of each node in the first enhanced graph may also be maximized.

S210: Perform node feature extraction on the data network graph based on an adjusted first network embedding model, to obtain an embedding vector configured for classifying each node in the data network graph.

By using the first network embedding model trained in the foregoing manner, an embedding vector that includes an important feature and is more robust in a balanced feature space may be extracted.

In an embodiment, the server may train a classifier using the embedding vector and a classification label until a prediction result is consistent with or similar to the classification label, and then stop the training of the classifier. After completing the training, the server may further deploy a trained first network embedding model and a trained classifier. When a classification task needs to be performed, in response to that the terminal may initiate a classification request, the server invokes the first network embedding model to perform feature extraction on a document citation relationship graph, a media interaction graph, or a social relationship graph that corresponds to the classification request, and classifies an extracted target embedding vector using the classifier, to obtain a final classification result.

In an embodiment, the operation of training the classifier using the embedding vector and the classification label may specifically include: The server classifies the embedding vector using the classifier, to obtain the prediction result; performs parameter adjustment on the classifier based on a loss value between the prediction result and the classification label; and stops a training process when an adjusted classifier reaches a convergence condition. After completing the training, the server may deploy the trained first network embedding model and the trained classifier.

When the classification task needs to be performed, the server performs a classification process in response to that the terminal may initiate the classification request. A processing process of a classification model is further described with reference to several specific application scenarios. Details are as follows:

Application scenario 1: A scenario of document classification.

In an embodiment, the server receives a document classification request initiated by the terminal, to obtain a document citation relationship graph; extracts a first embedding vector of the document citation relationship graph using the first network embedding model; and classifies the first embedding vector using the classifier, to obtain a subject or field of each document.

Application scenario 2: A scenario of classifying and pushing an interest for media.

In an embodiment, the server receives a media recommendation request initiated by the terminal, to obtain a media interaction graph; extracts a second embedding feature of the media interaction graph using the first network embedding model; classifies the second embedding feature using the classifier, to obtain an interest type corresponding to an object node; and recommends target media to a media account corresponding to the object node based on the interest type.

Application scenario 3: A scenario of classifying and pushing a communication group of interest.

In an embodiment, the server receives a group recommendation request initiated by the terminal, to obtain a social relationship graph; extracts a third embedding feature of the social relationship graph using the first network embedding model; classifies the third embedding feature using the classifier, to obtain a communication group in which a social object is interested; and pushes the communication group in which the social object is interested to the social object.

In the foregoing embodiment, node feature extraction is performed on the data network graph and the negative sample network graph using the first network embedding model, to obtain the positive sample embedding vector and the negative sample embedding vector. In addition, node feature extraction is further performed on two different enhanced graphs of the data network graph using the first network embedding model, to obtain the first global embedding vector and the second global embedding vector. The first matching degrees between the positive sample embedding vector and the first global embedding vector as well as the second global embedding vector are determined, and the second matching degrees between the negative sample embedding vector and the first global embedding vector as well as the second global embedding vector are determined. Because the foregoing enhanced graphs are obtained through enhancement on the data network graph, the positive sample embedding vector has a high matching degree with the first global embedding vector and the second global embedding vector, and the negative sample embedding vector has a low matching degree with the first global embedding vector and the second global embedding vector. Therefore, by adjusting the parameter of the first network embedding model based on the first matching degree and the second matching degree, the adjusted first network embedding model can learn an embedding vector that is robust and can accurately classify each node in the data network graph. In addition, a label of a node is not used in the training process. Therefore, a model learning process is not affected by most classes in the data network graph. Therefore, even if the data network graph is an imbalanced network graph, the model can learn a balanced feature space, so that the embedding vector includes an important feature and is more robust, thereby effectively improving a classification effect in a classification process. In addition, the trained first network embedding model and the trained classifier are used in different application scenarios, and corresponding classification processes may be implemented. For example, an embedding vector including a node feature may be obtained using the first network embedding model, and nodes in a document citation relationship graph, a media interaction graph, or a social relationship graph are accurately classified using the embedding vector, to respectively obtain a subject or field of each document, an interest type of an object, and a communication group in which the object is interested. This effectively improves the classification effect, and can also accurately push target media or the communication group in which the object is interested.

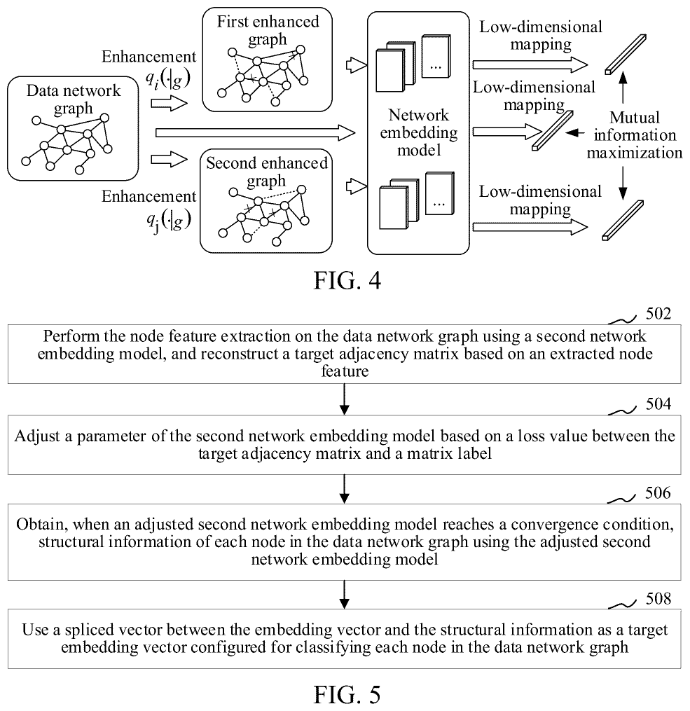

In an embodiment, the server performs first data enhancement on the data network graph, to obtain the first enhanced graph; and performs second data enhancement on the data network graph, to obtain the second enhanced graph, as shown in FIG. 4. The first data enhancement and the second data enhancement are separately at least one of feature masking, edge perturbation, or sub-graph extraction. The first data enhancement and the second data enhancement may be data enhancement in a same manner, or data enhancement in different manners. The first enhanced graph and the second enhanced graph are enhanced graphs of the data network graph, and may also be referred to as sub-graphs or enhanced sub-graphs.

Because both the first data enhancement and the second data enhancement may be the feature masking, the edge perturbation, or the sub-graph extraction, the foregoing data enhancement solutions may be divided into the following four scenarios for description.

Scenario 1: The first enhanced graph and the second enhanced graph are obtained through the feature masking.

In an embodiment, the server performs the feature masking on an image block in the data network graph, to obtain the first enhanced graph and the second enhanced graph. A feature value in a feature-masked image block is set to 0. During training of the first network embedding model, a masked feature may be inferred using a feature not masked in the data network graph.

Scenario 2: The first enhanced graph and the second enhanced graph are obtained through the edge perturbation.

In an embodiment, the server randomly adds or deletes an edge in the data network graph, to obtain the first enhanced graph and the second enhanced graph. For adding an edge in the data network graph or deleting an edge in the data network graph, uniform sampling may be performed following a principle of independent and identical distribution. For example, edges in the data network graph are randomly added or deleted based on a specific ratio. For example, 5% or 10% of the edges are randomly deleted, or 5% or 10% of the edges are randomly added.

Scenario 3: The first enhanced graph and the second enhanced graph are obtained through the sub-graph extraction.

In an embodiment, the server may perform node sampling in the data network graph, to obtain a first sampling node and a second sampling node. In the data network graph, gradual diffusion sampling is performed with the first sampling node as a center point, and a neighboring node sampled each time is placed into a first sampling set during the gradual diffusion sampling. When a quantity of nodes in the first sampling set reaches a target value, the sampling is stopped, to obtain the first enhanced graph. In the data network graph, the gradual diffusion sampling is performed with the second sampling node as the center point, and the neighboring node sampled each time is placed into a second sampling set during the gradual diffusion sampling. When a quantity of nodes in the second sampling set reaches the target value, the sampling is stopped, to obtain the second enhanced graph.

The first sampling node and the second sampling node may be randomly sampled nodes or fixed-point sampled nodes.

For an acquisition process of the first enhanced graph and the second enhanced graph, reference may be made to an algorithm process in Table 1 for details.

TABLE 1
Input: An original graph g=(V, E), a graph enhancement rate is k, and a sampled sub-graph gₛ =
(Vₛ, Eₛ), where Vₛ = Eₛ={ }, and a neighborhood node set V_{neigh} = { }
Output: The sampled sub-graph gₛ
1: sample a node in an original graph, and if v ϵ V, Vₛ={v}, and V_{neigh} = {v};
2: while |Vₛ|≤(1−k) |V| do,
3: a node is sampled from a neighboring node, and v ϵ V_{neigh};
4: if v ϵ Vₛ, then:
5: restart a loop;
6: update a sampling set and a neighborhood node set:
Vₛ = Vₛ ∪ {v}, and V_{neigh}=N(v);
7: update and edit: Eₛ = {e|e ϵ E and (e[0] ϵ Vₛ or e[1] ϵ Vₛ)}
8: return gₛ

Scenario 4: The first enhanced graph and the second enhanced graph are obtained in a hybrid manner.

In an embodiment, the server selects a sampling node in the data network graph, performs gradual diffusion sampling with the first sampling node as a center point, and places a neighboring node sampled each time into a first sampling set during the gradual diffusion sampling. When a quantity of nodes in the first sampling set reaches a target value, the sampling is stopped, to obtain the first enhanced graph. In addition, feature masking is performed on the data network graph, to obtain the second enhanced graph.

In another embodiment, the server selects a sampling node in the data network graph, performs gradual diffusion sampling with the first sampling node as a center point, and places a neighboring node sampled each time into a first sampling set during the gradual diffusion sampling. When a quantity of nodes in the first sampling set reaches a target value, the sampling is stopped, to obtain the first enhanced graph. In addition, edge perturbation is performed on the data network graph, to obtain the second enhanced graph.

In another embodiment, the server performs feature masking on the data network graph, to obtain the first enhanced graph. In addition, edge perturbation is performed on the data network graph, to obtain the second enhanced graph.

In the foregoing embodiment, data enhancement is performed on the data network graph. In this case, enhanced graphs at different angles can be obtained, so that when model training is performed using the enhanced graph, the model can be universal and can be adapted to various scenarios.

In an embodiment, to further improve the classification effect, the embedding vector extracted by the first network embedding model may be spliced with structural information of the data network graph, and a spliced vector obtained by splicing is used as a target embedding vector configured for classifying each node in the data network graph. Specifically, as shown in FIG. 5, the method further includes the following operations.

S502: Perform node feature extraction on the data network graph using a second network embedding model, and reconstruct a target adjacency matrix based on an extracted node feature.

The second network embedding model belongs to a structure preserving module, and is configured to perform structure reconstruction on the data network graph. The second network embedding model may be a graph convolutional network model, a graph attention network model, or a graph isomorphism network model. For example, the graph convolutional network model may be a network model including at least one layer of graph convolutional network.

In an embodiment, S502 may specifically include: The server obtains the feature matrix and the adjacency matrix of the nodes in the data network graph, inputs the feature matrix and the adjacency matrix of the nodes in the data network graph into the second network embedding model, extracts a degree matrix corresponding to the adjacency matrix of the nodes in the data network graph using the second network embedding model, and determines the node feature based on the adjacency matrix of the nodes in the data network graph, the degree matrix, the feature matrix, and a weight matrix of the second network embedding model. Then, the target adjacency matrix is reconstructed based on the node feature and a transposed matrix of the node feature.

For example, when the second network embedding model is a network model including one layer of graph convolutional network, the second network embedding model extracts the degree matrix corresponding to the adjacency matrix of the nodes in the data network graph, and determines the node feature based on the adjacency matrix of the nodes in the data network graph, the degree matrix, the feature matrix, and a weight matrix of the graph convolutional network.

To clearly describe the foregoing calculation process, a calculation formula of the graph convolutional network is given herein, and details are as follows:

$${H}_{s} = σ ( {\tilde{D}}^{- \frac{1}{2}} \tilde{A} {\tilde{D}}^{- \frac{1}{2}} XU )$$

where Hₛ represents a node feature outputted by the graph convolutional network; Ã is the adjacency matrix of the nodes in the data network graph, and the adjacency matrix is an adjacency matrix with a loop added; \tilde{D} is a degree matrix of Ã; U is a learnable weight matrix of the graph convolutional network; and σ ( ) is an activation function.

After the node feature is extracted, the server enables, in a form of reconstructing the target adjacency matrix, the embedding of the model to retain original structural information in the data network graph. An expression of reconstruction is as follows:

Â=Hₛ^{T}Hₛ
where Â is the reconstructed target adjacency matrix, and Hₛ^{T} is the transposed matrix of the node feature.

S504: Adjust a parameter of the second network embedding model based on a loss value between the target adjacency matrix and a matrix label.

The matrix label is a real adjacency matrix of the data network graph, and may be, for example, an adjacency matrix of the nodes in the data network graph added with a loop or an adjacency matrix without a loop added.

In an embodiment, the server calculates the loss value between the target adjacency matrix and the matrix label based on a target loss function, and then adjusts the parameter of the second network embedding model using the loss value. An expression of the target loss function is as follows:

$$L = - \frac{1}{N} {\sum }_{i} {\sum }_{j} {( {\hat{a}}_{ij} - {\tilde{a}}_{ij} )}^{2}$$

where L represents the loss value, N is a quantity of nodes in the data network graph, i and j respectively represent an i^{th} line and a j^{th} column in the data network graph, âᵢⱼ is a reconstructed target adjacency matrix of nodes of the i^{th} line and the j^{th} column, and ãᵢⱼ is a real adjacency matrix of the nodes of the i^{th} line and the j^{th} column in the data network graph.

S506: Obtain, when an adjusted second network embedding model reaches a convergence condition, structural information of each node in the data network graph using the adjusted second network embedding model.

By minimizing the target loss function, the second network embedding model reaches the convergence condition, so that the second network embedding model can learn how to extract an adjacency matrix closest to the real adjacency matrix. Therefore, after training of the second network embedding model is completed, structural information of an original structure of the data network graph is obtained and retained using the second network embedding model.

S508: Use a spliced vector between the embedding vector and the structural information as a target embedding vector configured for classifying each node in the data network graph.

In an embodiment, the server may respectively obtain, using the first network embedding model and the second network embedding model, the embedding vector including the node feature and the structural information of each node. To cause the node to obtain a more comprehensive expression capability, the embedding vector and the structural information are spliced, to obtain the target embedding vector configured for classifying each node in the data network graph. An expression of the target embedding vector is as follows:

$${H}_{f} = ( {H}_{tf} ‖ {H}_{sf} )$$

where H_{f} represents the target embedding vector, H_{tf} represents the embedding vector of each node in the data network graph extracted by the first network embedding model, and H_{sf} represents the structural information extracted by the second network embedding model.

In an embodiment, after S508, the method further includes: The server classifies the target embedding vector using a classifier, to obtain a prediction result; performs parameter adjustment on the classifier based on a loss value between the prediction result and a classification label; and stops a training process when an adjusted classifier reaches a convergence condition.

For the classifier, a linear model such as a single-layer neural network or a support vector machine may be selected as the classifier. The selection of a linear model as the classifier can effectively reduce impact brought by the classifier, so that a classification effect mainly depends on quality of the target embedding vector learned by the model. A linear mapping formula of the classifier is as follows:

$$\hat{Y} = g ( {WH}_{f} + b )$$

where Ŷ∈R^{N×C} represents the prediction result outputted by the classifier, and the prediction result may be a prediction result in a matrix form; and g( ) is an optional scaling function such as softmax ( ) and W and b are a learnable mapping matrix and a deviation. Next, the classifier is trained by minimizing a loss function.

L=l(Y,Ŷ)

Y is a true classification label of the node in the data network graph. Herein, for a different classifier, a different loss function such as a cross entropy loss function or a hinge loss function may be used.

In the foregoing embodiment, the second network embedding model is trained, so that the second network embedding model can learn the extraction of the structural information, thereby extracting the structural information consistent with or close to the original structure of the data network graph. The structural information is spliced with an embedding vector including a node key feature extracted by the first network embedding model, so that a target embedding vector including the node key feature and the structural information can be obtained, so that the target embedding vector has a more comprehensive expression capability and robustness, and the classification effect can be effectively improved.

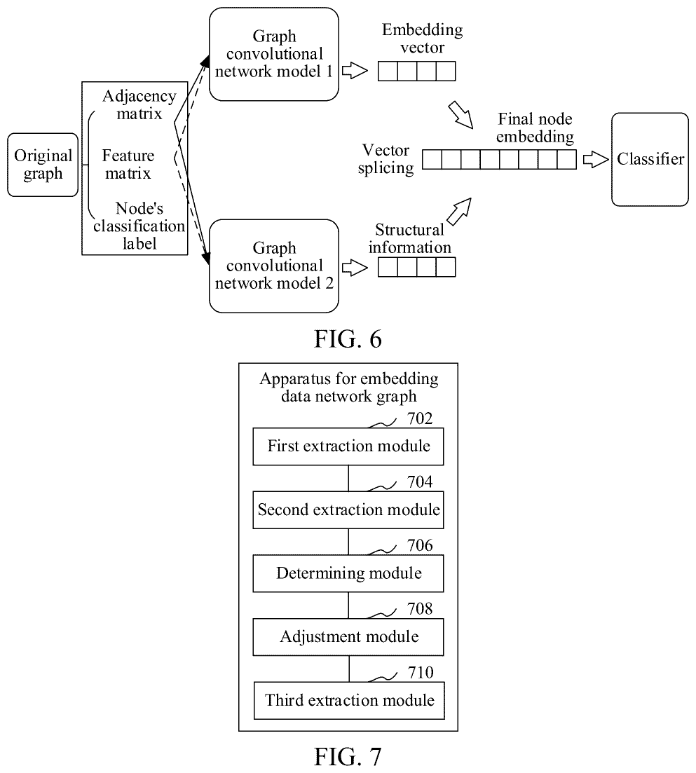

To make solutions of the present disclosure clearer, further descriptions are provided herein with reference to FIG. 6. Details are as follows:

In a training process of the present disclosure, three modules in a classification model are trained separately. To be specific, a self-supervised learning module, a network retention module, and a classifier are trained. It is assumed that both the self-supervised learning module and the network retention module use a graph convolutional network model (namely, a graph convolutional network model 1 or a graph convolutional network model 2). Then, during training, the graph convolutional network model 1 and the graph convolutional network model 2 may be trained simultaneously, and then the classifier is trained. A specific training process is as follows:

First, data enhancement is performed on an original graph (such as a document citation relationship graph) using a pre-defined graph enhancement algorithm, to obtain two enhanced sub-graphs under different perspectives, and then feature extraction is performed on the enhanced sub-graph, the original graph, and a negative sample graph separately using the graph convolutional network model 1, to obtain an embedding vector of a corresponding graph. Then, the graph convolutional network model 1 is optimized using contrastive learning with mutual information maximization, so that the learned embedding vector includes robust and key feature information.

Then, convolution and transformation operations are performed on nodes in the original graph using the graph convolutional network model 2, to obtain corresponding node features. Then, an adjacency matrix is reconstructed based on the node features, and a loss value between the reconstructed adjacency matrix and a real graph adjacency matrix is minimized, so that rich structural information can be extracted by a trained graph convolutional network model 2.

Finally, the embedding vector including the node features obtained by the graph convolutional network model 1 is spliced with the structural information obtained by the graph convolutional network model 2, to obtain a final target embedding vector. The target embedding vector includes the important node features and the rich structural information. The classifier is trained using the target embedding vector and label information of the node.

Particularly, because there is no fixed execution order for the self-supervised module and the structure preserving module, operations of the two may be performed in parallel, thereby improving timeliness of the model.

To verify a technical effect of this embodiment of the present disclosure, the following data and comparison manners are used. Reference may be made to Table 2 to Table 5.

Cora graph dataset: It is a graph dataset abstracted from an academic citation network, is a graph dataset including papers of machine learning as nodes, and includes 2708 nodes, 5429 edges, and 7 labels. Each node in the Cora graph dataset represents a paper, an edge between the nodes represents a citation relationship between the papers, an initial feature of each paper is generated by a bags-of-words model, and a label of each node refers to a research topic of the paper.

Citeseer graph dataset: It is a graph dataset about an academic citation network, and includes 3327 nodes, 5429 edges, and 6 labels. The node and the edge respectively represent a document and a citation relationship between documents, a node feature thereof is generated by a bags-of-words model, and a label of each node represents a research field to which the document belongs.

Pubmed graph dataset: It is a graph dataset formed based on biological papers, and includes 19717 nodes, 44338 edges, and 3 labels. A label of a node in the graph dataset represents a disease type (for example, a diabetes type) discussed in a corresponding biological paper, and a node feature thereof is generated by a bags-of-words model.

Flickr graph dataset: It is a graph dataset extracted from a picture and video sharing website. In the sharing website, users communicate with each other in a manner of sharing pictures and videos. The graph dataset includes 7575 nodes, 239738 edges, and 9 labels. The node represents a user, the edge between the nodes represents a relationship between users, and a node label represents an interest group corresponding to the user.

BlogCatalog graph dataset: It is a graph dataset derived from a social media website, a node therein represents a user, an edge between nodes represents a following relationship between users, a node feature thereof is generated by a word2vec model, and a label of a node represents an interest group that the user joins. The dataset includes 5196 nodes, 171743 edges, and 6 labels.

TABLE 2

| | Quantity of | Quantity of | Quantity of | Feature |
|---|---|---|---|---|
| Dataset | nodes | edges | categories | dimension |
| Cora graph dataset | 2708 | 5429 | 7 | 1433 |
| Citeseer graph dataset | 3327 | 4732 | 6 | 3703 |
| Pubmed graph dataset | 19717 | 44338 | 3 | 500 |
| Flickr graph dataset | 7575 | 239738 | 9 | 12047 |
| BlogCatalog graph | 5196 | 171743 | 6 | 8189 |
| dataset | | | | |

To prove effectiveness of the model in the present disclosure, the model is compared with a commonly used network embedding model, and a method is compared with a method commonly used for dealing with an imbalance problem. In addition, the model is also compared with some recently published models designed for an imbalance problem on network data. A comparison method used in the present disclosure is specifically described as follows:

### (1) Network Embedding Model:

GCN: It is the most widely used benchmark model in network embedding, and currently most network models are improved based on it. It aggregates embedding of a neighborhood through a topology relationship represented by an adjacency matrix, and learns a corresponding embedding vector for each node.

APPNP: It is a representation of a network decoupled model. It reduces a quantity of parameters by deconstructing feature propagation and feature transformation. In addition, it improves a feature transfer manner based on personalized PageRank, thereby expanding a perception domain of the model.

SGC: It is a simple linear model transformed from a non-linear GCN model, and collapses a function into a linear transformation by removing non-linear calculation between layers of the GCN, thereby reducing additional complexity of the GCNs, and an effect is superior to that of the GCN in some experiments.

### (2) General Method for the Imbalance Problem:

Re-weight: It belongs to an algorithm of a cost-sensitive type. It allocates a high loss weight to a minority class and a low weight to a majority class, to alleviate a problem that a loss descending direction is dominated by the majority class.

Over-sampling: A specific method of over-sampling is to perform repeated sampling from samples of a minority class, and then an extracted sample is added to a minority class set again, so that a dataset becomes balanced. In an experiment, an extracted node still retains an original adjacency relationship of the node.

### (3) Recent Imbalanced Network Embedding Method:

RECT: It is an embedding model based on a graph convolutional network, and is designed for a complete imbalance problem. It assists learning of an imbalanced model by enabling, through feature decomposition, a modeling inter-class relationship, and a network structure, the model to learn semantic information corresponding to each type of sample.

GraphSMOTE: First, a new node of a minority class is generated by interpolation, then an edge classifier is trained to add connection edges to the nodes to balance a network, and finally, node embedding generation is performed.

The foregoing models perform node classification on graph datasets with different imbalance rates, and obtain the following results:

TABLE 3
Graph dataset with an imbalance rate of 0.1

| | | Cora | Citeseer | Pubmed | Flickr | BlogCatalog |
|---|---|---|---|---|---|---|
| | | graph | graph | graph | graph | graph |
| Model | Indicator | dataset | dataset | dataset | dataset | dataset |
| GCN | Micro-F1 | 0.5784 | 0.4542 | 0.6317 | 0.4622 | 0.6527 |
| | Micro-F1 | 0.5382 | 0.4136 | 0.5397 | 0.3813 | 0.6363 |
| Re-weight | Micro-F1 | 0.6345 | 0.4765 | 0.6425 | 0.4757 | 0.6657 |
| | Micro-F1 | 0.6132 | 0.4443 | 0.5644 | 0.4103 | 0.6512 |
| Over-sampling | Micro-F1 | 0.5896 | 0.4602 | 0.6422 | 0.4572 | 0.6651 |
| | Micro-F1 | 0.5486 | 0.4187 | 0.5877 | 0.3895 | 0.6528 |
| APPNP | Micro-F1 | 0.6086 | 0.4635 | 0.6533 | 0.5062 | 0.6852 |
| | Micro-F1 | 0.5621 | 0.3876 | 0.5761 | 0.4378 | 0.6611 |
| SGC | Micro-F1 | 0.5645 | 0.4768 | 0.6538 | 0.4279 | 0.6431 |
| | Micro-F1 | 0.5026 | 0.4119 | 0.5702 | 0.3609 | 0.6271 |
| RECT | Micro-F1 | 0.6551 | 0.5442 | 0.6298 | 0.5275 | 0.6713 |
| | Micro-F1 | 0.6248 | 0.5209 | 0.5325 | 0.4475 | 0.6602 |
| grapSMOTE | Micro-F1 | 0.6357 | 0.4783 | 0.6883 | 0.3472 | 0.6831 |
| | Micro-F1 | 0.6273 | 0.4444 | 0.6496 | 0.2837 | 0.6321 |
| Solution | Micro-F1 | 0.6807 | 0.5611 | 0.6831 | 0.5261 | 0.8146 |
| in this | Micro-F1 | 0.6547 | 0.5407 | 0.6321 | 0.4749 | 0.8069 |
| application | | | | | | |

TABLE 4
Graph dataset with an imbalance rate of 0.3

| | | Cora | Citeseer | Pubmed | Flickr | BlogCatalog |
|---|---|---|---|---|---|---|
| | | graph | graph | graph | graph | graph |
| Model | Indicator | dataset | dataset | dataset | dataset | dataset |
| GCN | Micro-F1 | 0.7385 | 0.5417 | 0.7397 | 0.5181 | 0.7197 |
| | Micro-F1 | 0.7372 | 0.5438 | 0.7229 | 0.4875 | 0.7157 |
| Re-weight | Micro-F1 | 0.7402 | 0.5512 | 0.7519 | 0.5359 | 0.7433 |
| | Micro-F1 | 0.7402 | 0.5511 | 0.7419 | 0.5173 | 0.7433 |
| Over-sampling | Micro-F1 | 0.7387 | 0.5338 | 0.7283 | 0.5196 | 0.7397 |
| | Micro-F1 | 0.7394 | 0.5327 | 0.7196 | 0.5026 | 0.7297 |
| APPNP | Micro-F1 | 0.7625 | 0.5785 | 0.7616 | 0.5391 | 0.7259 |
| | Micro-F1 | 0.7619 | 0.5751 | 0.7434 | 0.5131 | 0.8367 |
| SGC | Micro-F1 | 0.7472 | 0.5913 | 0.7294 | 0.4951 | 0.8376 |
| | Micro-F1 | 0.7448 | 0.5905 | 0.7039 | 0.4788 | 0.7187 |
| RECT | Micro-F1 | 0.7863 | 0.6338 | 0.7136 | 0.5374 | 0.7155 |
| | Micro-F1 | 0.7875 | 0.6371 | 0.6861 | 0.5281 | 0.7052 |
| grapSMOTE | Micro-F1 | 0.7488 | 0.5517 | 0.7561 | 0.3651 | 0.7218 |
| | Micro-F1 | 0.7515 | 0.5556 | 0.7502 | 0.2929 | 0.7202 |
| Solution | Micro-F1 | 0.8086 | 0.6679 | 0.7739 | 0.5544 | 0.8767 |
| in this | Micro-F1 | 0.8071 | 0.6712 | 0.7522 | 0.5369 | 0.8765 |
| application | | | | | | |

TABLE 5
Graph dataset with an imbalance rate of 0.5

| | | Cora | Citeseer | Pubmed | Flickr | BlogCatalog |
|---|---|---|---|---|---|---|
| | | graph | graph | graph | graph | graph |
| Model | Indicator | dataset | dataset | dataset | dataset | dataset |
| GCN | Micro-F1 | 0.7482 | 0.6008 | 0.7828 | 0.5784 | 0.7342 |
| | Micro-F1 | 0.7512 | 0.6015 | 0.7765 | 0.5667 | 07292 |
| Re-weight | Micro-F1 | 0.7748 | 0.6075 | 0.7965 | 0.5895 | 0.7488 |
| | Micro-F1 | 0.7766 | 0.6074 | 0.7918 | 0.5845 | 0.7449 |
| Over-sampling | Micro-F1 | 0.7739 | 0.5987 | 0.7749 | 0.5788 | 0.7471 |
| | Micro-F1 | 0.7752 | 0.5998 | 0.7727 | 0.5747 | 0.7432 |
| APPNP | Micro-F1 | 0.8114 | 0.6438 | 0.7961 | 0.5408 | 0.8435 |
| | Micro-F1 | 0.8113 | 0.6472 | 0.7896 | 0.5298 | 0.8435 |
| SGC | Micro-F1 | 0.7957 | 0.6521 | 0.7845 | 0.5408 | 0.7405 |
| | Micro-F1 | 0.7971 | 0.6544 | 0.7769 | 0.5267 | 0.7385 |
| RECT | Micro-F1 | 0.8116 | 0.6647 | 0.7498 | 0.5855 | 0.7379 |
| | Micro-F1 | 0.8124 | 0.6679 | 0.7399 | 0.5835 | 0.7366 |
| grapSMOTE | Micro-F1 | 0.7835 | 0.6076 | 0.7963 | 0.4251 | 0.7049 |
| | Micro-F1 | 0.7855 | 0.6118 | 0.7949 | 0.3989 | 0.7005 |
| Solution | Micro-F1 | 0.8289 | 0.6839 | 0.8004 | 0.6109 | 0.8802 |
| in this | Micro-F1 | 0.8298 | 0.6837 | 0.7954 | 0.6032 | 0.8796 |
| application | | | | | | |

As illustrated in Table 3 to Table 5, as the data is greater, a corresponding effect is better. Therefore, it can be known from the data in Table 3 to Table 5 that the solution in the present disclosure achieves the best experimental effect under the two indicators: Micro-F and Macro-F.

After the trained first network embedding model, the trained second network embedding model, and the trained classifier are obtained, the first network embedding model, the second network embedding model, and the classifier may be combined into a classification model and deployed on a corresponding service platform, so that when a classification request is received, a classification processing process is performed. The processing process of the classification model is further described with reference to several specific application scenarios. Details are as follows:

Application scenario 1: A scenario of document classification.

In an embodiment, the server receives a document classification request initiated by the terminal, to obtain a document citation relationship graph corresponding to the document classification request; extracts a first embedding vector of the document citation relationship graph using the first network embedding model; extracts first structure data of the document citation relationship graph using the second network embedding model; and classifies, using the classifier, the target embedding vector obtained by splicing the first embedding vector and the first structure data, to obtain a subject or field of each document.

The document citation relationship graph may be a network graph constructed based on a dataset obtained from an academic citation network. A node in the document citation relationship graph corresponds to a document, for example, a paper. An edge between nodes in the document citation relationship graph corresponds to a citation relationship. If a document 2 cites a document 1, a node of the document 1 is connected to a node of the document 2.

Application scenario 2: A scenario of classifying and pushing an interest for media.

In an embodiment, the server receives a media recommendation request initiated by the terminal, to obtain a media interaction graph corresponding to the media recommendation request; extracts a second embedding feature of the media interaction graph using the first network embedding model; extracts second structure data of the media interaction graph using the second network embedding model; classifies, using the classifier, the target embedding vector obtained by splicing the second embedding feature and the second structure data, to obtain an interest type corresponding to an object node; and recommends target media to a media account corresponding to the object node based on the interest type.

The media interaction graph may be a network graph obtained from a media sharing platform for reflecting interaction between an object and media, and the media may be any one of Photo, Music, Video, and Livestreaming room. The interaction between the object and the media may be that the object clicks/taps to browse a picture, plays a piece of music or a video, watches a livestreaming room, or the like. The media interaction graph includes the object node and a media node.

Through the foregoing manner, an interest type of the object, for example, an interest in what type of media, for example, an interest in a science fiction type of film or an interest in a rock music, can be accurately inferred, and then target media in which the object is interested is recommended to the object, so that an on-demand rate of the media can be improved.

Application scenario 3: A scenario of classifying and pushing a communication group of interest.

In an embodiment, the server receives a group recommendation request initiated by the terminal, to obtain a social relationship graph corresponding to the group recommendation request; extracts a third embedding feature of the social relationship graph using the first network embedding model; extracts third structure data of the social relationship graph using the second network embedding model; classifies, using the classifier, the target embedding vector obtained by splicing the third embedding feature and the third structure data, to obtain a communication group in which a social object is interested; and pushes the communication group in which the social object is interested to the social object.

The social relationship graph includes an object node of the social object. If there is a following relationship between the social objects, the object nodes corresponding to the social objects are connected to each other. By classifying the social relationship graph, a communication group (for example, an interest group in a group chat) in which each social object is interested may be obtained.

In the foregoing embodiment, the trained first network embedding model, the trained second network embedding model, and the trained classifier are used in different application scenarios, and corresponding classification processes may be implemented. For example, the target embedding vector including the node feature and the structure data may be obtained using the first network embedding model and the second network embedding model, and nodes in the document citation relationship graph, the media interaction graph, or the social relationship graph are accurately classified using the target embedding vector, to respectively obtain a subject or field of a document, an interest type of an object, and a communication group in which the object is interested. This effectively improves the classification effect, and can also accurately push the target media or the communication group in which the object is interested.

Although the operations in the flowcharts involved in the foregoing embodiments are displayed sequentially according to instructions of arrows, the operations are not necessarily performed sequentially according to a sequence instructed by the arrows. Unless clearly specified in this specification, the operations are performed without any strict sequence limit, and may be performed in other sequences. In addition, at least some operations in the flowcharts involved in the foregoing embodiments may include a plurality of operations or a plurality of stages. The operations or the stages are not necessarily performed at the same moment, but may be performed at different moments. The operations or the stages are not necessarily performed in sequence, but may be performed in turn or alternately with another operation or at least some of operations or stages of the another operation.

Based on a same invention conception, this embodiment of the present disclosure further provides an apparatus for embedding a data network graph configured to implement the foregoing involved method for embedding a data network graph. An implementation solution for solving the problem provided by the apparatus is similar to the implementation solution recorded in the foregoing method, so that for a specific limitation on one or more apparatus embodiments for embedding a data network graph provided below, reference may be made to the limitation on the method for embedding a data network graph above, and details are not described herein again.

In an embodiment, as shown in FIG. 7, an apparatus for embedding a data network graph is provided, including: a first extraction module 702, a second extraction module 704, a determining module 706, an adjustment module 708, and a third extraction module 710.

The first extraction module 702 is configured to perform node feature extraction on the data network graph and a negative sample network graph using a first network embedding model, to obtain a positive sample embedding vector and a negative sample embedding vector, the data network graph being a positive sample network graph and being an imbalanced network graph constructed based on an imbalanced object dataset.

The second extraction module 704 is configured to perform node feature extraction on a first enhanced graph and a second enhanced graph of the data network graph using the first network embedding model, to obtain a first global embedding vector and a second global embedding vector.

The determining module 706 is configured to determine first matching degrees between the positive sample embedding vector and the first global embedding vector as well as the second global embedding vector, and determine second matching degrees between the negative sample embedding vector and the first global embedding vector as well as the second global embedding vector.

The adjustment module 708 is configured to determine a loss value based on the first matching degree and the second matching degree, and adjust a parameter of the first network embedding model based on the loss value.

The third extraction module 710 is configured to perform node feature extraction on the data network graph based on an adjusted first network embedding model, to obtain an embedding vector configured for classifying each node in the data network graph.

In the foregoing embodiment, node feature extraction is performed on the data network graph and the negative sample network graph using the first network embedding model, to obtain the positive sample embedding vector and the negative sample embedding vector. In addition, node feature extraction is further performed on two different enhanced graphs of the data network graph using the first network embedding model, to obtain the first global embedding vector and the second global embedding vector. The first matching degrees between the positive sample embedding vector and the first global embedding vector as well as the second global embedding vector are determined, and the second matching degrees between the negative sample embedding vector and the first global embedding vector as well as the second global embedding vector are determined. Because the foregoing enhanced graphs are obtained through enhancement on the data network graph, the positive sample embedding vector has a high matching degree with the first global embedding vector and the second global embedding vector, and the negative sample embedding vector has a low matching degree with the first global embedding vector and the second global embedding vector. Therefore, by adjusting the parameter of the first network embedding model based on the first matching degree and the second matching degree, the adjusted first network embedding model can learn an embedding vector that is robust and can accurately classify each node in the data network graph. In addition, a label of a node is not used in the training process. Therefore, a model learning process is not affected by most classes in the data network graph. Therefore, even if the data network graph is an imbalanced network graph, the model can learn a balanced feature space, so that the embedding vector includes an important feature and is more robust, thereby effectively improving a classification effect in a classification process.

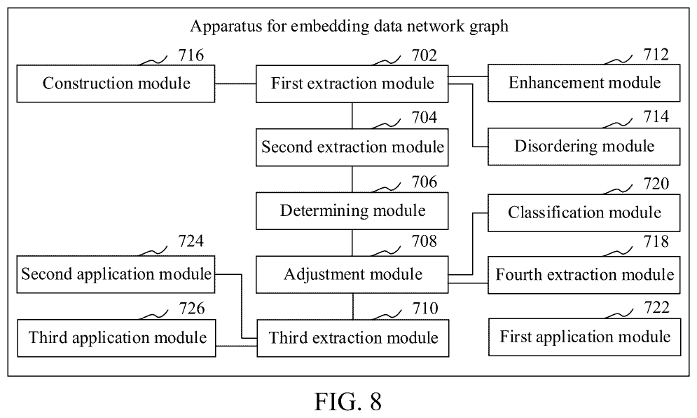

In one of the embodiments, as shown in FIG. 8, the apparatus further includes:
an enhancement module 712, configured to perform first data enhancement on the data network graph, to obtain the first enhanced graph; and perform second data enhancement on the data network graph, to obtain the second enhanced graph. The first data enhancement and the second data enhancement are separately at least one of feature masking, edge perturbation, or sub-graph extraction.

In one of the embodiments, the enhancement module 712 is further configured to select a sampling node in the data network graph, perform gradual diffusion sampling with the first sampling node as a center point, and place a neighboring node sampled each time into a first sampling set during the gradual diffusion sampling. When a quantity of nodes in the first sampling set reaches a target value, the sampling is stopped, to obtain the first enhanced graph. Feature masking is performed on the data network graph, to obtain the second enhanced graph.

In the foregoing embodiment, data enhancement is performed on the data network graph. In this case, enhanced graphs at different angles can be obtained, so that when model training is performed using the enhanced graph, the model can be universal and can be adapted to various scenarios.

In one of the embodiments, as shown in FIG. 8, the apparatus further includes:
a disordering module 714, configured to perform out-of-order processing on a feature corresponding to each node in the data network graph, to obtain the negative sample network graph, a node structure of the negative sample network graph being consistent with a node structure of the data network graph.

In one of the embodiments, as shown in FIG. 8, the apparatus further includes:
a construction module 716, configured to obtain the object dataset and an association relationship between each piece of object data in the object dataset; and construct the data network graph using each piece of object data in the object dataset as a node and using the association relationship as an edge of the node.

In one of the embodiments, the first enhanced graph and the second enhanced graph are enhanced graphs obtained by performing data enhancement on the data network graph.

The second extraction module 704 is further configured to extract a first local embedding vector and a second local embedding vector of each node from the first enhanced graph and the second enhanced graph respectively using the first network embedding model; and perform pooling on the first local embedding vector and the second local embedding vector respectively, to obtain the first global embedding vector and the second global embedding vector.

In one of the embodiments, the second extraction module 704 is further configured to obtain a first adjacency matrix and a first feature matrix of nodes in the first enhanced graph; input the first adjacency matrix and the first feature matrix into the first network embedding model, to cause the first network embedding model to generate the first local embedding vector of each node in the first enhanced graph based on the first adjacency matrix, a degree matrix of the first adjacency matrix, the first feature matrix, and a weight matrix of the first network embedding model; obtain a second adjacency matrix and a second feature matrix of nodes in the second enhanced graph; and input the second adjacency matrix and the second feature matrix into the first network embedding model, to cause the first network embedding model to generate the second local embedding vector of each node in the second enhanced graph based on the second adjacency matrix, a degree matrix of the second adjacency matrix, the second feature matrix, and the weight matrix of the first network embedding model.

In one of the embodiments, as shown in FIG. 8, the apparatus further includes:
a fourth extraction module 718, configured to perform node feature extraction on the data network graph using the second network embedding model, and reconstruct a target adjacency matrix based on an extracted node feature.

The adjustment module 708 is further configured to adjust a parameter of the second network embedding model based on a loss value between the target adjacency matrix and a matrix label.

The fourth extraction module 718 is further configured to obtain, when an adjusted second network embedding model reaches a convergence condition, structural information of each node in the data network graph using the adjusted second network embedding model; and use a spliced vector between the embedding vector and the structural information as a target embedding vector configured for classifying each node in the data network graph.

In one of the embodiments, as shown in FIG. 8, the apparatus further includes:
a classification module 720, configured to classify the target embedding vector using a classifier, to obtain a prediction result.

The adjustment module 708 is further configured to perform parameter adjustment on the classifier based on a loss value between the prediction result and a classification label; and stop a training process when an adjusted classifier reaches the convergence condition.

In the foregoing embodiment, the second network embedding model is trained, so that the second network embedding model can learn the extraction of the structural information, thereby extracting the structural information consistent with or close to the original structure of the data network graph. The structural information is spliced with an embedding vector including a node key feature extracted by the first network embedding model, so that a target embedding vector including the node key feature and the structural information can be obtained, so that the target embedding vector has a more comprehensive expression capability and robustness, and the classification effect can be effectively improved.

In one of the embodiments, as shown in FIG. 8, the apparatus further includes:
a first application module 722, configured to obtain a document citation relationship graph; extract a first embedding vector of the document citation relationship graph using the first network embedding model; extract first structure data of the document citation relationship graph using the second network embedding model; and classify, using the classifier, the target embedding vector obtained by splicing the first embedding vector and the first structure data, to obtain a subject or field of each document.

In one of the embodiments, as shown in FIG. 8, the apparatus further includes:
a second application module 724, configured to obtain a media interaction graph; extract a second embedding feature of the media interaction graph using the first network embedding model; extract second structure data of the media interaction graph using the second network embedding model; classify, using the classifier, the target embedding vector obtained by splicing the second embedding feature and the second structure data, to obtain an interest type corresponding to an object node; and recommend target media to a media account corresponding to the object node based on the interest type.

In one of the embodiments, as shown in FIG. 8, the apparatus further includes:
a third application module 726, configured to obtain a social relationship graph; extract a third embedding feature of the social relationship graph using the first network embedding model; extract third structure data of the social relationship graph using the second network embedding model; classify, using the classifier, the target embedding vector obtained by splicing the third embedding feature and the third structure data, to obtain a communication group in which a social object is interested; and push the communication group in which the social object is interested to the social object.

In the foregoing embodiment, the trained first network embedding model, the trained second network embedding model, and the trained classifier are used in different application scenarios, and corresponding classification processes may be implemented. For example, the target embedding vector including the node feature and the structure data may be obtained using the first network embedding model and the second network embedding model, and nodes in the document citation relationship graph, the media interaction graph, or the social relationship graph are accurately classified using the target embedding vector, to respectively obtain a subject or field of a document, an interest type of an object, and a communication group in which the object is interested. This effectively improves the classification effect, and can also accurately push the target media or the communication group in which the object is interested.

The modules in the foregoing apparatus for embedding a data network graph may be implemented entirely or partially by software, hardware, or a combination thereof. The foregoing modules may be built in or independent of a processor of a computer device in a hardware form, or may be stored in a memory of the computer device in a software form, so that the processor invokes and performs an operation corresponding to each of the foregoing modules.

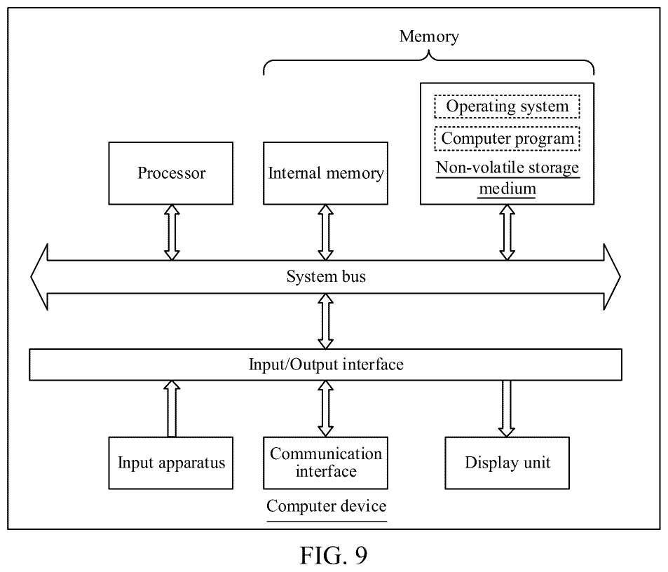

In an embodiment, a computer device is provided. The computer device may be a server, and a diagram of an internal structure thereof may be shown in FIG. 9. The computer device includes a processor, a memory, an input/output (I/O) interface, and a communication interface. The processor, the memory, and the input/output interface are connected through a system bus, and the communication interface is connected to the system bus through the input/output interface. The processor of the computer device is configured to provide computing and control capabilities. The memory of the computer device includes a non-volatile storage medium and an internal memory. The non-volatile storage medium has an operating system, a computer program, and a database stored therein. The internal memory provides an environment for running the operating system and the computer program in the non-volatile storage medium. The database of the computer device is configured to store a data network graph, a negative sample network graph, and an enhanced graph. The input/output interface of the computer device is configured for information exchange between the processor and an external device. The communication interface of the computer device is configured to communicate with an external terminal through a network connection. The computer program is executed by the processor to implement a method for embedding a data network graph.

A person skilled in the art may understand that, the structure shown in FIG. 9 is only a block diagram of a part of a structure related to a solution of the present disclosure and does not limit the computer device to which the solution of the present disclosure is applied. Specifically, the computer device may include more or fewer members than those in the drawings, or include a combination of some members, or include different member layouts.

In an embodiment, a computer device is provided, including a memory and a processor, the memory having a computer program stored therein, the computer program, when executed by the processor, implementing the operations of the foregoing method for embedding a data network graph.

In an embodiment, a computer-readable storage medium is provided, having a computer program stored therein, the computer program, when executed by a processor, implementing the operations of the foregoing method for embedding a data network graph.

In an embodiment, a computer program product is provided, including a computer program, the computer program, when executed by a processor, implementing the operations of the foregoing method for embedding a data network graph.

User information (including but not limited to user device information, user personal information, and the like) and data (including but not limited to data used for analysis, stored data, displayed data, and the like) involved in the present disclosure are authorized by the user or fully authorized by all parties, and the collection, use and processing of relevant data need to comply with relevant laws, regulations and standards of relevant countries and regions.

The term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

A person of ordinary skill in the art may understand that all or some of procedures of the method in the foregoing embodiments may be implemented by a computer program instructing relevant hardware. The computer program may be stored in a non-volatile computer-readable storage medium. When the computer program is executed, the procedures of the foregoing method embodiments may be implemented. Any reference to the memory, the database, or another medium used in the embodiments provided in the present disclosure may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may include a random access memory (RAM), an external cache, or the like. For the purpose of description instead of limitation, the RAM is available in a plurality of forms, such as a static random access memory (SRAM) or a dynamic random access memory (DRAM). The database involved in each embodiment provided in the present disclosure may include at least one of a relational database and a non-relational database. The non-relational database may include a blockchain-based distributed database, and the like, and is not limited thereto. The processor involved in each embodiment provided in the present disclosure may be a general-purpose processor, a central processing unit, a graphics processing unit, a digital signal processor, a programmable logic device, a quantum calculation-based data processing logic device, or the like, and is not limited thereto.

Technical features of the foregoing embodiments may be combined in different manners to form other embodiments. For concise description, not all possible combinations of the technical features in the foregoing embodiments are described. However, provided that combinations of the technical features do not conflict with each other, the combinations of the technical features are considered as falling within the scope recorded in this specification.

The foregoing embodiments merely express several implementations of the present disclosure. The descriptions are specific and detailed, but are not to be understood as a limitation to the patent scope of the present disclosure. A person of ordinary skill in the art may further make variations and improvements without departing from the concept of the present disclosure, and these shall all fall within the protection scope of the present disclosure. Therefore, the protection scope of the present disclosure shall be subject to the appended claims.

What is claimed is:

1. A method for embedding a data network graph, performed by a computer device, the method comprising:
performing node feature extraction on the data network graph and a negative sample network graph using a first network embedding model, to obtain a positive sample embedding vector and a negative sample embedding vector, the data network graph being a positive sample network graph and being an imbalanced network graph constructed based on an imbalanced object dataset;
performing node feature extraction on a first enhanced graph and a second enhanced graph of the data network graph using the first network embedding model, to obtain a first global embedding vector and a second global embedding vector;
determining first matching degrees between the positive sample embedding vector and the first global embedding vector as well as the second global embedding vector, and determining second matching degrees between the negative sample embedding vector and the first global embedding vector as well as the second global embedding vector;
determining a loss value based on the first matching degrees and the second matching degrees, and adjusting a parameter of the first network embedding model based on the loss value; and
performing node feature extraction on the data network graph based on an adjusted first network embedding model, to obtain an embedding vector configured for classifying a node in the data network graph.

2. The method according to claim 1, further comprising:
performing first data enhancement on the data network graph, to obtain the first enhanced graph; and
performing second data enhancement on the data network graph, to obtain the second enhanced graph,
the first data enhancement and the second data enhancement being respectively at least one of feature masking, edge perturbation, or sub-graph extraction.

3. The method according to claim 2, wherein performing the first data enhancement on the data network graph, to obtain the first enhanced graph comprises:
selecting a sampling node in the data network graph, performing gradual diffusion sampling with a first sampling node as a center point, and placing a neighboring node sampled each time into a first sampling set during the gradual diffusion sampling; and
when a quantity of nodes in the first sampling set reaches a target value, stopping the sampling, to obtain the first enhanced graph; and
performing the second data enhancement on the data network graph, to obtain the second enhanced graph comprises:
performing feature masking on the data network graph, to obtain the second enhanced graph.

4. The method according to claim 1, further comprising:
performing out-of-order processing on a feature corresponding to each node in the data network graph, to obtain the negative sample network graph,
a node structure of the negative sample network graph being consistent with a node structure of the data network graph.

5. The method according to claim 1, further comprising:
obtaining the object dataset and an association relationship between each piece of object data in the object dataset; and
constructing the data network graph using each piece of object data in the object dataset as a node and using the association relationship as an edge of the node.

6. The method according to claim 1, wherein performing the node feature extraction on the first enhanced graph and the second enhanced graph of the data network graph using the first network embedding model, to obtain the first global embedding vector and the second global embedding vector comprises:
extracting a first local embedding vector and a second local embedding vector of each node from the first enhanced graph and the second enhanced graph respectively using the first network embedding model; and
performing pooling on the first local embedding vector and the second local embedding vector respectively, to obtain the first global embedding vector and the second global embedding vector.

7. The method according to claim 6, wherein extracting the first local embedding vector and the second local embedding vector of each node from the first enhanced graph and the second enhanced graph respectively using the first network embedding model comprises:
obtaining a first adjacency matrix and a first feature matrix of nodes in the first enhanced graph; inputting the first adjacency matrix and the first feature matrix into the first network embedding model, to cause the first network embedding model to generate the first local embedding vector of each node in the first enhanced graph based on the first adjacency matrix, a degree matrix of the first adjacency matrix, the first feature matrix, and a weight matrix of the first network embedding model; and
obtaining a second adjacency matrix and a second feature matrix of nodes in the second enhanced graph; and inputting the second adjacency matrix and the second feature matrix into the first network embedding model, to cause the first network embedding model to generate the second local embedding vector of each node in the second enhanced graph based on the second adjacency matrix, a degree matrix of the second adjacency matrix, the second feature matrix, and the weight matrix of the first network embedding model.

8. The method according to claim 1, further comprising:
classifying the embedding vector using a classifier, to obtain a prediction result;
performing parameter adjustment on the classifier based on a loss value between the prediction result and a classification label; and
stopping a training process when an adjusted classifier reaches a convergence condition.

9. The method according to claim 8, further comprising:
obtaining a document citation relationship graph;
extracting a first embedding vector of the document citation relationship graph using the first network embedding model; and
classifying the first embedding vector using the classifier, to obtain a subject or field of each document.

10. The method according to claim 8, further comprising:
obtaining a media interaction graph;
extracting a second embedding feature of the media interaction graph using the first network embedding model;
classifying the second embedding feature using the classifier, to obtain an interest type corresponding to an object node; and
recommending target media to a media account corresponding to the object node based on the interest type.

11. The method according to claim 8, further comprising:
obtaining a social relationship graph;
extracting a third embedding feature of the social relationship graph using the first network embedding model;
classifying the third embedding feature using the classifier, to obtain a communication group in which a social object is interested; and
pushing the communication group in which the social object is interested to the social object.

12. The method according to claim 1, further comprising:
performing node feature extraction on the data network graph using a second network embedding model, and reconstructing a target adjacency matrix based on an extracted node feature;
adjusting a parameter of the second network embedding model based on a loss value between the target adjacency matrix and a matrix label;
obtaining, when an adjusted second network embedding model reaches a convergence condition, structural information of each node in the data network graph using the adjusted second network embedding model; and
using a spliced vector between the embedding vector and the structural information as a target embedding vector configured for classifying each node in the data network graph.

13. The method according to claim 12, further comprising:
classifying the target embedding vector using a classifier, to obtain a prediction result;
performing parameter adjustment on the classifier based on a loss value between the prediction result and a classification label; and
stopping a training process when an adjusted classifier reaches the convergence condition.

14. The method according to claim 12, further comprising:
obtaining a document citation relationship graph;
extracting a first embedding vector of the document citation relationship graph using the first network embedding model;
extracting first structure data of the document citation relationship graph using the second network embedding model; and
classifying, using the classifier, the target embedding vector obtained by splicing the first embedding vector and the first structure data, to obtain a subject or field of each document.

15. The method according to claim 12, further comprising:
obtaining a media interaction graph;
extracting a second embedding feature of the media interaction graph using the first network embedding model;
extracting second structure data of the media interaction graph using the second network embedding model;
classifying, using the classifier, the target embedding vector obtained by splicing the second embedding feature and the second structure data, to obtain an interest type corresponding to an object node; and
recommending target media to a media account corresponding to the object node based on the interest type.

16. The method according to claim 12, further comprising:
obtaining a social relationship graph;
extracting a third embedding feature of the social relationship graph using the first network embedding model;
extracting third structure data of the social relationship graph using the second network embedding model;
classifying, using the classifier, the target embedding vector obtained by splicing the third embedding feature and the third structure data, to obtain a communication group in which a social object is interested; and
pushing the communication group in which the social object is interested to the social object.

17. A computer device, comprising a memory and at least one processor, the memory containing a computer program that, when being executed, causes the at least one processor to implement:
performing node feature extraction on the data network graph and a negative sample network graph using a first network embedding model, to obtain a positive sample embedding vector and a negative sample embedding vector, the data network graph being a positive sample network graph and being an imbalanced network graph constructed based on an imbalanced object dataset;
performing node feature extraction on a first enhanced graph and a second enhanced graph of the data network graph using the first network embedding model, to obtain a first global embedding vector and a second global embedding vector;
determining first matching degrees between the positive sample embedding vector and the first global embedding vector as well as the second global embedding vector, and determining second matching degrees between the negative sample embedding vector and the first global embedding vector as well as the second global embedding vector;
determining a loss value based on the first matching degrees and the second matching degrees, and adjusting a parameter of the first network embedding model based on the loss value; and
performing node feature extraction on the data network graph based on an adjusted first network embedding model, to obtain an embedding vector configured for classifying a node in the data network graph.

18. The computer device according to claim 17, wherein the at least one processor is further configured to perform:
performing first data enhancement on the data network graph, to obtain the first enhanced graph; and
performing second data enhancement on the data network graph, to obtain the second enhanced graph, the first data enhancement and the second data enhancement being respectively at least one of feature masking, edge perturbation, or sub-graph extraction.

19. The computer device according to claim 18, wherein the at least one processor is further configured to perform:
selecting a sampling node in the data network graph, performing gradual diffusion sampling with a first sampling node as a center point, and placing a neighboring node sampled each time into a first sampling set during the gradual diffusion sampling; and
when a quantity of nodes in the first sampling set reaches a target value, stopping the sampling, to obtain the first enhanced graph; and
performing the second data enhancement on the data network graph, to obtain the second enhanced graph comprises:
performing feature masking on the data network graph, to obtain the second enhanced graph.

20. A non-transitory computer-readable storage medium containing a computer program that, when being executed, causes at least one processor to implement:
performing node feature extraction on the data network graph and a negative sample network graph using a first network embedding model, to obtain a positive sample embedding vector and a negative sample embedding vector, the data network graph being a positive sample network graph and being an imbalanced network graph constructed based on an imbalanced object dataset;
performing node feature extraction on a first enhanced graph and a second enhanced graph of the data network graph using the first network embedding model, to obtain a first global embedding vector and a second global embedding vector;
determining first matching degrees between the positive sample embedding vector and the first global embedding vector as well as the second global embedding vector, and determining second matching degrees between the negative sample embedding vector and the first global embedding vector as well as the second global embedding vector;
determining a loss value based on the first matching degrees and the second matching degrees, and adjusting a parameter of the first network embedding model based on the loss value; and
performing node feature extraction on the data network graph based on an adjusted first network embedding model, to obtain an embedding vector configured for classifying a node in the data network graph.
